(19) United States
(12) Patent Application Publication
(10) Pub. No.: US 2012/0280947 A1
(43) Pub. Date: Nov. 8, 2012

(54) STYLUS WITH PRESSURE SENSITIVE MEMBRANE

(75) Inventors: Billy L. WEAVER, Eagan, MN (US); Karl M. KROPP, Saint Paul, MN (US)

(73) Assignee: 3M Innovative Properties Company

(21) Appl. No.: 13/102,457

(22) Filed: May 6, 2011

(51) Int. Cl. G06F 3/033

(52) U.S. Cl. 345/179; 178/19.04

(57) ABSTRACT

A stylus including a pressure sensitive membrane deployed as a pressure sensor therein. The pressure sensitive membrane is deformed upon the application of pressure to the stylus tip. The deformation changes an electrical property of the pressure sensitive membrane, said property being measured and used as an analog for pressure applied by a user to a surface via the stylus.

### BACKGROUND

A stylus offers a convenient way of interacting with a computing device, such as a tablet computer.

### SUMMARY

A stylus incorporating a pressure sensitive membrane (PSM) is described. The PSM is configured within the stylus to be compressed when pressure is applied to the stylus tip, as would be the case when a user is using the stylus tip for interacting with a computing device (for example, using the stylus as a writing instrument on a tablet computer). The compression of the PSM causes the PSM's electrical resistance to change. This change is sensed by electronics, which provide signals indicative of such change which may then be used to, for example, indicate when a stylus is active and thereby signal that particular stylus-sensing electronics should be activated. Or, for example, the relative degree of change could be used to indicate the pressure a user is applying, via the stylus, to a writing surface. Such information could be used, in association with coordinate information related to the stylus tip, to, for example, modify the thickness of a virtual trace drawn upon the display of a tablet computer. Particularly, if a user is pressing harder with her stylus against the tablet's display, a corresponding trace displayed by the tablet could be correspondingly darker and heavier, not unlike a line that would be drawn using an ordinary pencil but with lighter versus heavier pressure applied from the pencil to a sheet of paper.

In one embodiment, a stylus for performing writing, gesture, or command motions on the surface of a contact-sensitive device is described, the stylus comprising a pressure sensitive membrane disposed within the stylus; circuitry electrically coupled to the pressure sensitive membrane; a stylus tip; and wherein pressure encountered by the stylus tip is transferred to the pressure sensitive membrane.

This and other embodiments are more fully described herein.

### BRIEF DESCRIPTION OF THE DRAWINGS

FIG. 1 is a schematic of a stylus.

### DETAILED DESCRIPTION

Pressure sensitive membranes (PSMs) are membrane substrates that have an electrical property that changes as a function of deformation of the substrate. For example, a PSM, when deformed, may become increasingly electrically conductive and thereby allow the flow of electricity through the substrate. Such a membrane, and associated construction techniques, are described in U.S. Pat. No. 5,209,967 “Pressure Sensitive Membrane and Method Therefor” (Wright, et. al.), which is fully incorporated by reference into this disclosure. PSMs are not the same as conductive inks, which have a bulk resistance that does not change under load. Such inks typically have a surface structure that prevents intimate contact to form between conductive pads to a surface of the ink itself, and increased force between conductive pads increases the contact area between one of the conductive pads and the ink surface.

Briefly, one type of such PSMs comprise a fibrillated polytetrafuoroethylene (PTFE) matrix having enmeshed therein (a) electrically conductive particles (polymeric microspheres of carbon, for example), and (b) electrically nonconductive, energy expanded polymeric particles. The PSM may be placed between two conductive surfaces, such as metal plates, and can serve as a reversible electrical circuit making element (switch) when an electrical current is provided, such as from a power supply. Flow of current is inhibited by the large bulk resistance of the PSM. When pressure is applied such that the composite article is deformed by compression, the resistance within the PSM drops by several orders of magnitude, thereby allowing for more flow of electrical current through the circuit. When the applied force is removed, the bulk resistance of the composite membrane increases and current ceases to flow or flows less readily. It has been discovered that such PSMs may be advantageously disposed as a sensor within an electronic stylus to provide useful information concerning the stylus's state. For example, an electronic stylus that is used to interact with a contact sensitive display screen may utilize information provided by the sensor to determine when the stylus is active, and thereby activate (possibly from a “sleeping” state of low energy consumption) electronics associated with identifying the position of the stylus tip. Further, information from the sensor may be deemed indicative of a particular and interesting types of user input (stylus pressure), which may be utilized by computer applications in myriad of ways. For example, a drawing program or a signature capture program may modify traces drawn on a corresponding display using a stylus based on changes in stylus pressure, generating on a display bolder traces when pressure is higher, and lighter traces when pressure is lower. Other computer applications my take advantage of a stylus's pressure-related information in other ways.

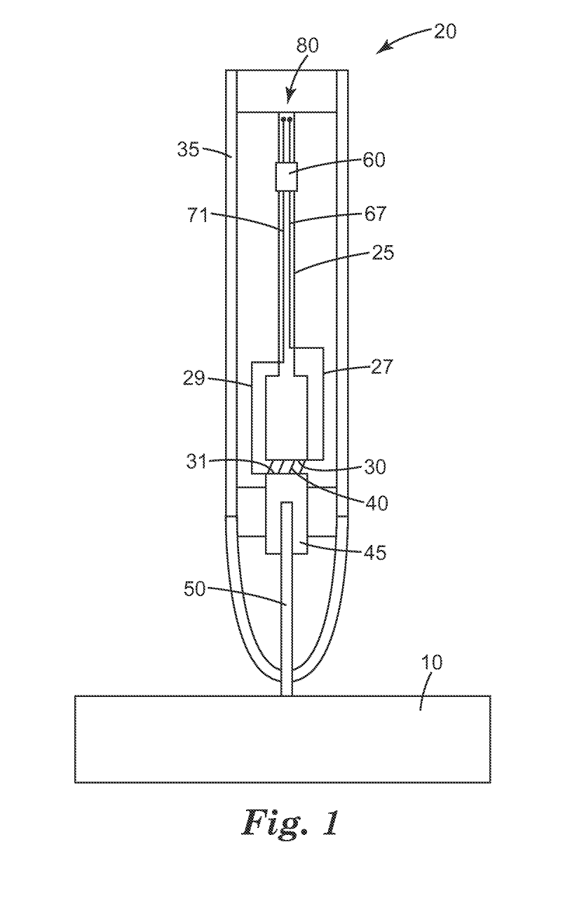

FIG. 1 is a schematic of a stylus 20 that employs a PSM as a sensor. The stylus includes a body, or housing 35, which may be plastic, metal, or the like. Stylus tip 50 transfers pressure resulting from contact with substrate 10 to PSM 40. Stylus tip may be a plastic or metal or any suitable material. FIG. 1 shows an embodiment where stylus tip 50 extends beyond stylus body 35, but other embodiments are possible, such as for example wherein the tip area of the stylus body is a readily deformable plastic material and the stylus tip instead resides within the stylus body. No matter the particular configuration chosen, the stylus tip 50 interfaces with substrate 10 and transfers forces associated with said interface to the PSM 40. Anvil 45 may optionally be used to provide for a larger surface area by which pressure is transmitted from the stylus tip to PSM 40, or otherwise interface between pressure stylus tip 50 and PSM 40. Anvil 45 may be comprised of any suitable material, and in one preferred embodiment is plastic. PSM 40 is a PSM as described above, in one embodiment having a thickness of about 20 mils. Substrate 10 may be any substrate, but in one preferred embodiment is the surface of a digitizer responsive to stylus input, such as a stylus-enabled tablet computer.

Circuit board 25 is a printed circuit assembly, including conductors 67 and 71, which couple to a first and a second conductive pad (30 and 31). As shown in FIG. 1, wires 27 and 29 are used to couple conductors 67 and 71 to circuit conductive pads 30 and 31. Conductive pads 30 and 31 are solid or surface conductive material, including copper foil, copper conductor, or the like. The flexibility of such wires accommodates the relative movement of the conductive pads towards and away from each other, during the presence or absence of pressure as from a contact event with stylus tip 50. This could also be accomplished with a flexible circuit. The use of wires is optional, and other configurations where the circuit board is designed to bend for example, are understood to be contemplated herein. PSM 40 is shown sandwiched between conductive pad 30 and 31, though other configurations are possible.

Signal conditioning electronics 60 is shown disposed on a portion of circuit board 25. Signal conditioning electronics may comprise various analog signal modifying elements, such as resistors and amplifiers, as necessary, in order to take measurements of the conductivity between pads 30 and 31, through PSM 40. In one embodiment, signal conditioning electronics 60 comprises a 1K resistor disposed on one of the conductors.

Terminal areas 80 are conductive connection points used to couple the conductors to measurement electronics, which are not shown in FIG. 1 but in one embodiment comprises an analog-to-digital converter (ADC). The ADC measures conductivity between pads 30 and 31 and converts this into a digital representation of the resistance between the pads. Measurement electronics in one embodiment may be included in the stylus body 35, or may be disposed elsewhere and the conductors 67 and 71 coupled to the measurement electronics via, for example, a tethering cable. Wireless configurations are also possible, and these would generally involve the ADC disposed within body 35, and measurements therefrom provided via a radio located within body 35 to a receiving radio located elsewhere. In one embodiment, the stylus implements a wireless communications protocol managed by the Bluetooth Special Interest Group (Kirkland, Wash., USA), which is provided under the trade name Bluetooth. In such embodiment, information representative of the resistance between pads 30 and 31 is communicated to a receiving radio via said wireless communications protocol. Of course, other information may also be provided via the wireless communication protocol, including information concerning the location of stylus tip relative to a surface, using techniques that are known in the art; the use of the PSM 40 is coextensive and compatible with most if not all digitizing systems that use a stylus.

What we claim is:

1. A stylus for performing writing, gesture, or command motions on the surface of a contact-sensitive device comprising:
a pressure sensitive membrane disposed within the stylus;
circuitry electrically coupled to the pressure sensitive membrane;
a stylus tip; and,
wherein pressure encountered by the stylus tip is transferred to the pressure sensitive membrane.

2. The stylus of claim 1, wherein the circuitry is electrically coupled to measurement electronics, and wherein the measurement electronics receive signals related to an electrical property of the pressure sensitive membrane.

3. The stylus of claim 2, further comprising a stylus body, and wherein the pressure sensitive membrane is disposed within the stylus body.

4. The stylus of claim 3, wherein the measurement electronics are disposed within the stylus body.

5. The stylus of claim 4, further comprising a radio, and wherein signals related to the electrical property are transmitted via radio signals.

6. The stylus of claim 2, wherein the pressure encountered by the stylus tip that is transferred to the pressure sensitive membrane deforms the pressure sensitive membrane.

7. The stylus of claim 6, wherein the deformation of the pressure sensitive membrane changes an electrical property of the pressure sensitive membrane.

8. The stylus of claim 7, wherein the electrical property is resistance.

9. The stylus of claim 8, wherein the pressure sensitive membrane has a first side and a second side, and wherein circuitry electrically coupled to the pressure sensitive membrane comprises a first conductor coupled to the first side of the pressure sensitive membrane, and a second conductor coupled to the second side of the pressure sensitive membrane.

10. The stylus of claim 9, further comprising:
an anvil disposed between the stylus tip and the pressure sensitive membrane, and
wherein the pressure encountered by the stylus tip is transferred to the pressure sensitive membrane via the anvil.
